(19) United States
(12) Patent Application Publication
(10) Pub. No.: US 2011/0103446 A1
(43) Pub. Date: May 5, 2011

(54) Test System

(76) Inventors: Po-Yi Chen, Taipei Hsien (TW); Yi-Jui Chen, Taipei Hsien (TW); Min-Jung Wu, Taipei Hsien (TW); Feng-Chi Chan, Taipei Hsien (TW); Kuo-Wei Chen, Taipei Hsien (TW)

(21) Appl. No.: 12/797,612

(22) Filed: Jun. 10, 2010

(30) Foreign Application Priority Data
Oct. 30, 2009 (TW) 098136997

(51) Int. Cl. H04B 17/00

(52) U.S. Cl. 375/224

(57) ABSTRACT

A test system for testing an electronic device is disclosed. The test system includes a signal generator for generating an input signal, a signal splitter for splitting the input signal into a first splitting signal and a second splitting signal, a micro control unit for generating a first control signal and a second control signal, a first transmission interface for transmitting the first splitting signal and the first control signal, a second transmission interface for transmitting the second splitting signal and the second control signal, and a first signal adjustment unit for transforming the first splitting signal to a first test signal for test according to the first control signal.

### BACKGROUND OF THE INVENTION

1. Field of the Invention

The invention relates to a test system, and more particularly, to a test system capable of simultaneously providing multiple test signals with various signal strength.

2. Description of the Prior Art

For ensuring the quality of electronic products, product manufacturers usually perform many normal function inspections for each electronic product during the manufacturing process or after manufacturing in order to verify whether the electronic product works well and conforms to quality management requirements. For example, a signal reception function test is a common test item for electronic communication products, such as satellite broadcast receivers, set-top boxes, mobile communication devices, etc. In general, suppose an electronic communication product may receive communication signals of various signal strength due to various environmental or signal transmission variances. Therefore, during a testing procedure, various signals having various signal strength are provided to the electronic communication product for inspecting whether the electronic communication product can receive the related signals normally.

Please refer to FIG. 1, which is a schematic diagram of a test system 10 according to the prior art. The test system 10 includes a signal generator 102 and an attenuator 104. The signal generator 102 is utilized for generating a radio frequency (RF) signal S. The attenuator 104 is utilized for attenuating the RF signal S to a test signal ST provided to an electronic communication product 106 for testing.

The test system 10 is only able to test a single electronic communication product at one time. In practice, the above-mentioned structure cannot provide efficient testing for mass production. When multiple products need to be tested at the same time, more signal generators are needed for providing test signals, resulting in expensive cost. In addition, the signal generator needs to repeatedly adjust the output signal strength for various test signals during the test process, decreasing the service life of the signal generator. Therefore, designing a proper test system with a short production cycle and low cost for providing testing procedures should be a concern in progressive system design.

### SUMMARY OF THE INVENTION

It is therefore an objective of the invention to provide a test system.

The invention discloses a test system for testing an electronic device. The test system includes a signal generator, for generating an input signal; a signal splitter, for splitting the input signal into a first splitting signal and a second splitting signal; a micro control unit, for generating a first control signal and a second control signal; a first transmission interface, for transmitting the first splitting signal and the first control signal; a second transmission interface, for transmitting the second splitting signal and the second control signal; and a first signal adjustment unit, for transforming the first splitting signal to a first test signal for testing according to the first control signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a test system according to the prior art.

FIG. 2 is a schematic diagram of a test system according to an embodiment of the invention.

FIG. 3 is a schematic diagram of the signal adjustment unit shown in FIG. 2 according to an embodiment of the invention.

### DETAILED DESCRIPTION

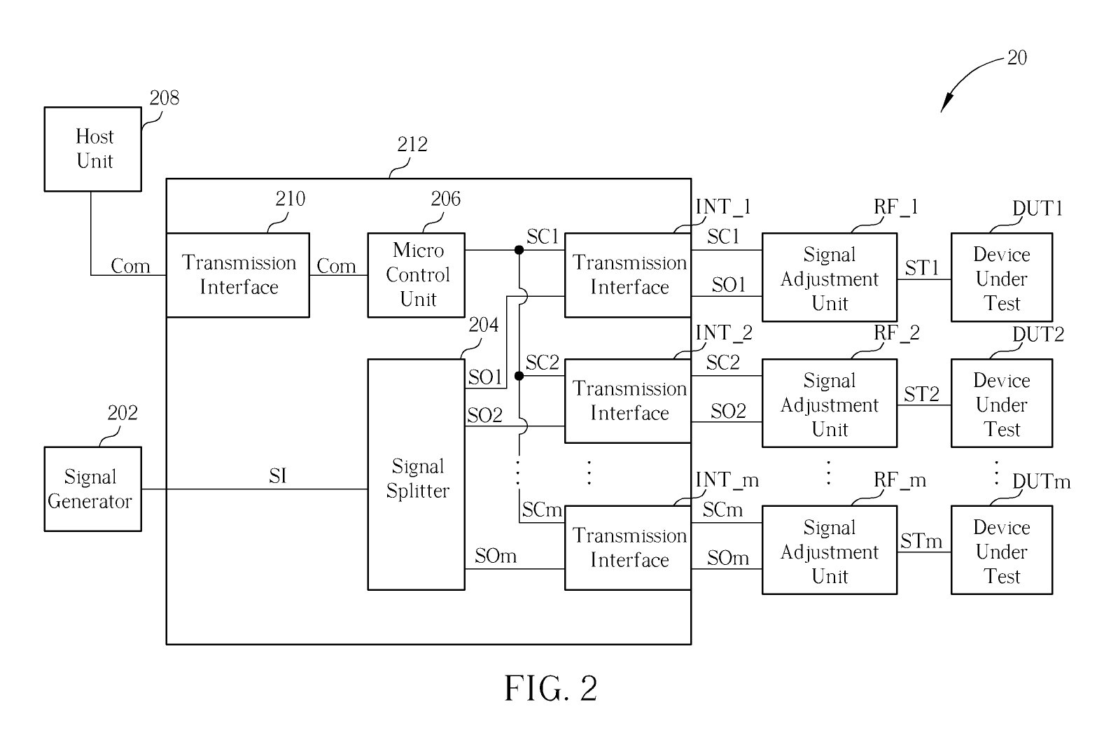

Please refer to FIG. 2, which is a schematic diagram of a test system 20 according to an embodiment of the invention. The test system 20 is utilized for simultaneously providing test signals ST1 to STm. Please note that signal strength of the test signals ST1 to STm can be flexibly adjusted depending on various requirements for being provided to a single device under test (DUT) or multiple DUTs for performing tests. The test system 20 includes a signal generator 202, a signal splitter 204, a micro control unit 206, a host unit 208, transmission interfaces 210 and INT_1 to INT_m, a printed circuit board 212, and signal adjustment units RF_1 to RF_m. The signal generator 202 is utilized for generating an input signal SI. The signal splitter 204 is utilized for splitting the input signal SI into splitting signals SO1 to SOm. The micro control unit 206 is utilized for generating control signals SC1 to SCm. The transmission interfaces INT_1 to INT_m are coupled to the signal splitter 204 and the micro control unit 206 for respectively transmitting the inputted splitting signal and control signal to the corresponding signal adjustment unit. The signal adjustment units RF_1 to RF_m are respectively coupled to the transmission interfaces INT_1 to INT_m for transforming the splitting signals SO1 to SOm to the test signals ST1 to STm with required signal strength according to the first control signals SC1 to SCm to the DUTs (DUT1 to DUTm).

Briefly, according to the desired signal strength of each DUT, the test system 20 can generate the corresponding control signals SC1 to SCm through the micro control unit 206 and further attenuate the splitting signals SO1 to SOm into the test signals ST1 to STm with required signal strength accordingly through the signal adjustment units RF_1 to RF_m. As a result, the test system 20 is capable of providing multiple test signals having various desired signal strengths for multiple DUTs at the same time.

Therefore, the invention can use a single signal generator 202 to provide the stable input signal SI and control the signal adjustment units RF_1 to RF_m to flexibly adjust signal strength via the micro control unit 206. In other words, the invention can provide multiple test signals with required signal strength by appropriate control configuration of the micro control unit 206 without repeatedly adjusting the output signal strength of the single signal generator 202.

Furthermore, in the test system 20, since the signal generator 202 provides the input signal SI, the input signal SI is further split into multiple independent splitting signals SO1 to SOm. In such a condition, the micro control unit 206 is able to properly control the signal adjustment units RF_1 to RF_m to transform the splitting signals SO1 to SOm into appropriate test signals. As shown in FIG. 2, to achieve signal strength control of each signal adjustment unit, the host unit 208 connected to the micro control unit 206 via the transmission interface 210 can provide a single strength command COM generated according to testing requirements to the micro control unit 206, and the micro control unit 206 generates the corresponding control signal accordingly. As a result, the test system 20 is able to arrange the desired test signal correctly through the above-mentioned operation. On the other hand, as shown in FIG. 2, the transmission interfaces 210, the signal generator 202, the signal splitter 204, the micro control unit 206, and the transmission interfaces INT_1 to INT_m can preferably be integrated in the printed circuit board 212 in practice, and this should not be a limitation of the invention.

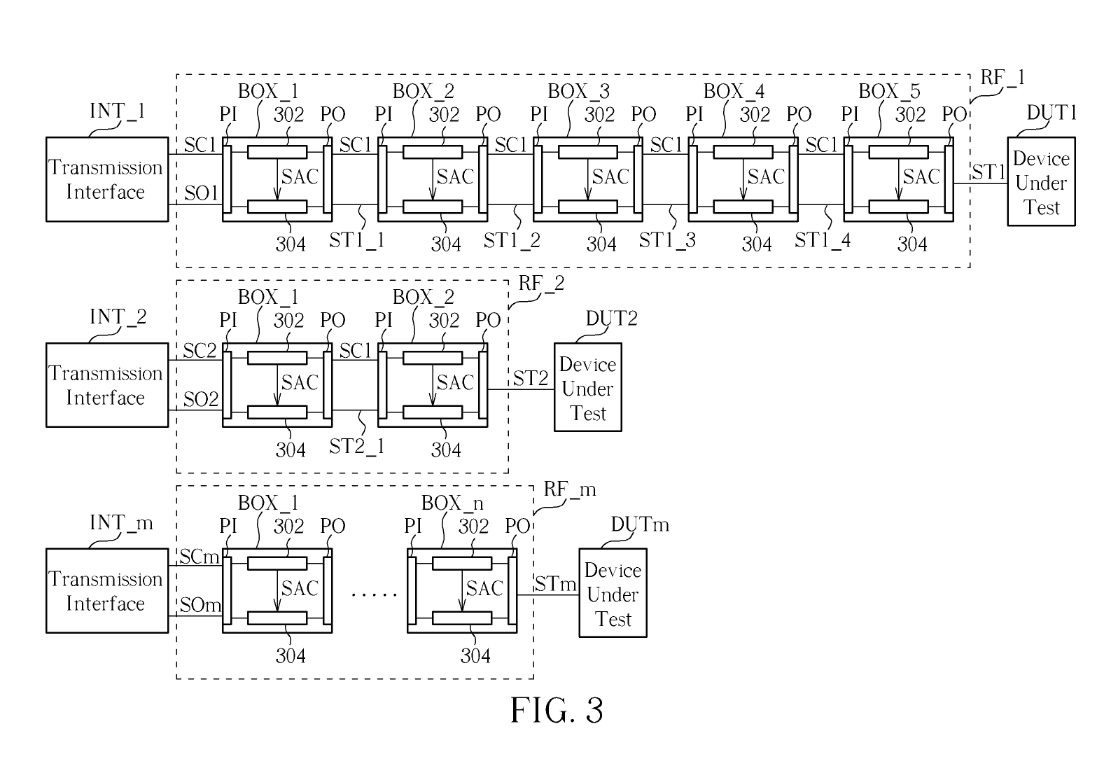

Regarding the signal adjustment units RF_1 to RF_m, please refer to FIG. 3. FIG. 3 is a schematic diagram of the signal adjustment unit shown in FIG. 2 according to an embodiment of the invention. As shown in FIG. 3, each signal adjustment unit includes one or more signal attenuation modules. For example, the signal adjustment unit RF_1 includes signal attenuation modules BOX_1 to BOX_5. The signal adjustment unit RF_2 includes signal attenuation modules BOX_1 to BOX_2. Each signal attenuation module can be utilized for performing signal attenuation. If the signal adjustment unit includes two or more signal attenuation modules, the signal attenuation modules of the signal adjustment unit can be connected in serial. Therefore, each signal adjustment unit can perform an attenuation process on the received splitting signal through the series-connected signal attenuation modules to generate the test signal with the corresponding signal strength. Please further refer to FIG. 3. Each signal attenuation module includes an input port PI, a signal control unit 302, an attenuator 304, and an output port PO. The input port PI is coupled to the corresponding transmission interface or the output port of the preceding-stage signal attenuation module for receiving the splitting signal from the corresponding transmission interface or the test signal from the preceding-stage and the corresponding control signal. The signal control unit 302 is coupled to the input port PI for generating an attenuation control signal SAC sent to the attenuator 304 according to the corresponding control signal and also transmitting the corresponding control signal to the output port PO. The attenuator 304 is coupled to the input port PI and the signal control unit 302 for attenuating the corresponding splitting signal or the test signal outputted from the previous stage according to the attenuation control signal SAC in order to generate the corresponding test signal. The output port PO is utilized for outputting the corresponding test signal generated by the attenuator 304 and the corresponding control signal received by the input port PI. In other words, for each signal adjustment unit, the splitting signal can be received from the corresponding transmission interface by the first-stage signal attenuation module. The received splitting signal can be attenuated to the test signal having desired signal strength by each stage signal attenuation module. Finally, the test signal can be outputted to the DUT through the output pot of the final-stage signal attenuation module.

Besides, the amount of signal attenuation modules for each signal adjustment unit depends on requirements and attenuation capability of the signal attenuation module. In the test system, the test signal should be not limited to being obtained from the final-stage signal attenuation module of each signal adjustment. This means any signal attenuation module which provides appropriate signal strength can be utilized for providing the required test signal. Also, the amount of signal attenuation modules for each signal adjustment unit can be varied depending on requirements. In other words, each signal adjustment unit has a large extensibility.

On the other hand, electromagnetic interference may be introduced during signal transmission when all the modules are on the same circuit board. In the embodiment, each signal attenuation module in a signal adjustment unit is an independent element, so that each signal attenuation module can be set in an independent attenuator circuit board to avoid electromagnetic interference. In addition, an electromagnetic interference shielding housing can be used on each signal attenuation module for reducing the electromagnetic interference effect.

For test application of the production line, taking into consideration various product characteristics and standard specifications, and environment variance, the test system needs to provide the test signal with various signal strengths to the DUT for various testing. The following further elaborates the operation of the test system 20. Please refer to FIG. 2 and FIG. 3. Taking satellite broadcast receivers as the DUTs for example, suppose each signal in the test system is a RF signal. Suppose the signal generator 202 generates a 2.3 GHz satellite broadcast signal (i.e. the input signal SI shown in FIG. 3), and the satellite broadcast signal is split into each signal adjustment unit via the signal splitter 204. If the device under test DUT1 needs a −10 dB test signal ST1 and the signal strength of the splitting signals SO1 is −0.1 dB, in such a condition, the micro control unit 206 can control each signal control unit 302 of the signal attenuation modules BOX_1 to BOX_5 to perform the corresponding attenuation process to provide the −10 dB test signal ST1 through the control signal SC1. In detail, the test system 20 can use the micro control unit 206 to arrange the splitting signals SO1 to be attenuated by the signal attenuation modules BOX_1 to BOX_5 so as to provide a −10 dB test signal ST1 to the satellite broadcast receiver DUT1. In the embodiment, the invention can flexibly allot the operation of each attenuator 304 through the micro control unit 206 to obtain the required test signal. In other words, the micro control unit 206 can arrange the amount of attenuation operations performed by each attenuator 304, such as equal attenuation by each attenuator 304 or processing by only certain attenuators.

For example, suppose the maximum attenuation capability of each attenuator 304 is 5 dB. The −0.1 dB splitting signals SO1 may be attenuated to a −3 dB test signal ST1_1 after the attenuation operation of the attenuator 304 in the signal attenuation module BOX_1. After that, the test signal ST1_1 is provided to the following stage (the attenuator 304 of the signal attenuation module BOX_2). The signal attenuation module BOX_2 attenuates the −3 dB test signal ST1_1 into a −5 dB test signal ST1_2. In a similar manner, the −5 dB test signal ST1_2 is further converted to a −7 dB test signal ST1_3, −9 dB test signal ST1_4, and a −10 dB test signal ST1 successively by the signal attenuation modules BOX_3 to BOX_5 accordingly. This way, the test system 20 can provide various test signals with various signal strengths for other DUTs in order to verify the signal reception capability of DUTs.

The test system 20 is an exemplary embodiment of the invention, and skilled people in the art can make alternations and modifications accordingly. For example, The devices under test DUT1 to DUTm can be any electronic product having the function of signal reception or processing. The attenuator 304 can be any kind of attenuator which correctly reduces the magnitude of signal. In addition, each attenuator 304 of the test system can have various signal attenuation capabilities for generating the desired test signal. On the other hand, the host unit 208 can be any device with a computing system. The transmission interface 210 can be any type of transmission interface which is able to transmit the data of the host unit 208 to the micro control unit 206, such as RS-233 interfaces or other serial or parallel transmission interfaces.

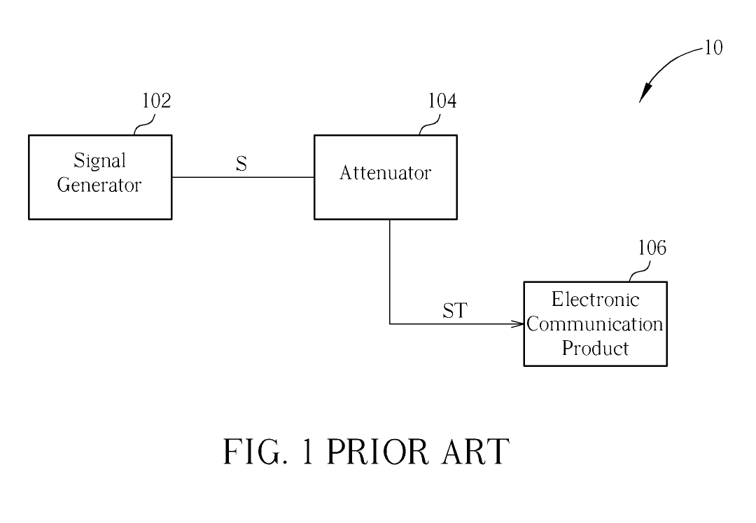

In summary, the invention can adaptively generate the test signals with required signal strengths through the signal strength control of the micro control unit 206 and extensible signal adjustment unit. In addition, in the prior art, if multiple DUTs need to be tested at the same time, the corresponding amount of test systems 10 shown in FIG. 1 are required, which may result in expensive manufacturing cost. Comparatively, the invention can simultaneously provide multiple test signal paths by only using a single signal generator, and can also provide test signals with various signal strengths depending on requirements. Therefore, the invention can enhance the test efficiency and reduce the manufacturing cost substantially.

Those skilled in the art will readily observe that numerous modifications and alterations of the device and method may be made while retaining the teachings of the invention.

What is claimed is:

1. A test system for testing an electronic device, comprising:
a signal generator, for generating an input signal;
a signal splitter, for splitting the input signal into a first splitting signal and a second splitting signal;
a micro control unit, for generating a first control signal and a second control signal;
a first transmission interface, for transmitting the first splitting signal and the first control signal;
a second transmission interface, for transmitting the second splitting signal and the second control signal; and
a first signal adjustment unit, for transforming the first splitting signal to a first test signal for testing according to the first control signal.

2. The test system of claim 1, wherein the first signal adjustment unit comprises a first-stage signal attenuation module.

3. The test system of claim 2, wherein the first-stage signal attenuation module comprises:
a signal control unit, for generating an attenuation control signal according to the first control signal; and
an attenuator, for adjusting the first splitting signal to generate the first test signal according to the attenuation control signal.

4. The test system of claim 2, wherein the first-stage signal attenuation module further comprises:
an electromagnetic interference unit, for reducing an electromagnetic interference effect generated by the first-stage signal attenuation module during operation.

5. The test system of claim 2, wherein the first signal adjustment unit further comprises a second-stage signal attenuation module, and the first-stage signal attenuation module and the second-stage signal attenuation module are connected in series.

6. The test system of claim 1 further comprising:
a second signal adjustment unit, for transforming the second splitting signal to a second test signal for testing according to the second control signal.

7. The test system of claim 1 further comprising:
a third transmission interface, coupled to the micro control unit, for providing data transmission; and
a host unit, coupled to the third transmission interface, for generating a signal strength command provided to the micro control unit via the third transmission interface for commanding the micro control unit to generate the first control signal and the second control signal accordingly.

8. The test system of claim 7, wherein the third transmission interface, the signal generator, the signal splitter, the micro control unit, the first transmission interface, and second transmission interface are integrated in a circuit board.

9. The test system of claim 1, wherein the input signal and the first test signal are radio frequency signals.
